(19) United States
(12) Patent Application Publication
(10) Pub. No.: US 2012/0007372 A1
(43) Pub. Date: Jan. 12, 2012

(54) VEHICLE LATCH WITH OVER TRAVEL STOP FEATURE

(76) Inventors: Kurt E. Nurmi, Macomb, MI (US); John F. Reelhorn, Pickerington, OH (US); Rogelio Terrazas, Juarez Chihuahua (MX)

(21) Appl. No.: 12/831,685

(22) Filed: Jul. 7, 2010

(51) Int. Cl. E05C 3/16

(52) U.S. Cl. 292/216

(57) ABSTRACT

A latch assembly is provided, the latch assembly having: a frame having a striker opening formed therein; a fork bolt pivotally secured to the latch assembly proximate to the striker opening for movement between an unlatched position and a latched position, the fork bolt having an opening configured to engage a striker when the striker is inserted into the striker opening and the fork bolt is in the unlatched position; and a feature located on an outer periphery of the fork bolt, the feature limiting pivotal movement of the fork bolt by contacting the striker when the striker is inserted into the striker opening and the striker is not received in the opening of the fork bolt.

### BACKGROUND

Exemplary embodiments of the present invention relate to vehicle latch assemblies and, more particularly to an over travel stop feature for a latch assembly.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A vehicle latch typically includes a fork bolt that is pivoted between an unlatched position and a primary latched position when a movable panel of the vehicle is closed to latch the movable panel in the closed position. The fork bolt is typically held in the primary latched position by a detent lever that pivots between an engaged position and a disengaged position. The detent lever is spring biased into the engaged position and thus, holds the fork bolt in the primary latched position when in the engaged position and releases the fork bolt when it is moved to the disengaged position so that the door can be opened.

The fork bolt is pivoted to the primary latched position by a striker attached to, for example, an associated movable panel when the movable panel is closed. Once in the primary latched position, the detent lever engages the fork bolt to ensure the assembly remains latched. Other systems utilize motors to assist in the closing of the movable panel.

Accordingly, it is desirable to provide a latch assembly wherein the fork bolt is not inadvertently moved past a latched position to an over travel position. More specifically, it is desirable to provide a feature for stopping movement of the fork bolt in order to prevent such undesired movement.

### SUMMARY OF THE INVENTION

In accordance with an exemplary embodiment of the invention, a latch assembly is provided, the vehicle latch assembly having: a frame having a striker opening formed therein; a fork bolt pivotally secured to the latch assembly proximate to the striker opening for movement between an unlatched position and a latched position, the fork bolt having an opening configured to engage a striker when the striker is inserted into the striker opening and the fork bolt is in the unlatched position; and a feature located on an outer periphery of the fork bolt, the feature limiting pivotal movement of the fork bolt by contacting the striker when the striker is inserted into the striker opening and the striker is not received in the opening of the fork bolt.

In another exemplary embodiment, a hood latch assembly in combination with a hood striker, the latch assembly having: a frame having a striker opening formed therein; a fork bolt pivotally secured to the latch assembly proximate to the striker opening for movement between an unlatched position and a latched position, the fork bolt having an opening configured to engage the hood striker when the hood striker is inserted into the striker opening and the fork bolt is in the unlatched position; and a feature located on an outer periphery of the fork bolt, the feature limiting pivotal movement of the fork bolt when the hood striker is inserted into the striker opening and the hood striker is not received in the opening of the fork bolt, wherein the hood striker is captured between the feature and a surface of the striker opening as the fork bolt pivots to the latched position when the hood striker is inserted into the striker opening and the hood striker is not received in the opening of the fork bolt.

In another exemplary embodiment, a method of limiting movement of a fork bolt of a vehicle latch assembly is provided, the method including the steps of: pivotally securing the fork bolt to the latch assembly for movement between an unlatched position and a latched position; limiting rotation of the fork bolt towards the unlatched position by capturing a striker between a feature disposed on an outer periphery of the fork bolt and a portion of a striker opening of a frame of the latch assembly; and preventing actuation of a switch by the fork bolt when the striker is captured between the feature of the fork bolt and the portion of the striker opening of the frame of the latch assembly.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a view illustrating a latch assembly in accordance with an exemplary embodiment of the present invention in an unlatched position wherein a striker is not engaged by the fork bolt;

FIG. 2 is a view illustrating a latch assembly of FIG. 1 in latched position wherein the fork bolt has engaged the striker;

FIG. 3 is a view illustrating a latch assembly in accordance with an exemplary embodiment of the present invention in an unlatched position wherein a striker has contacted the fork bolt; and

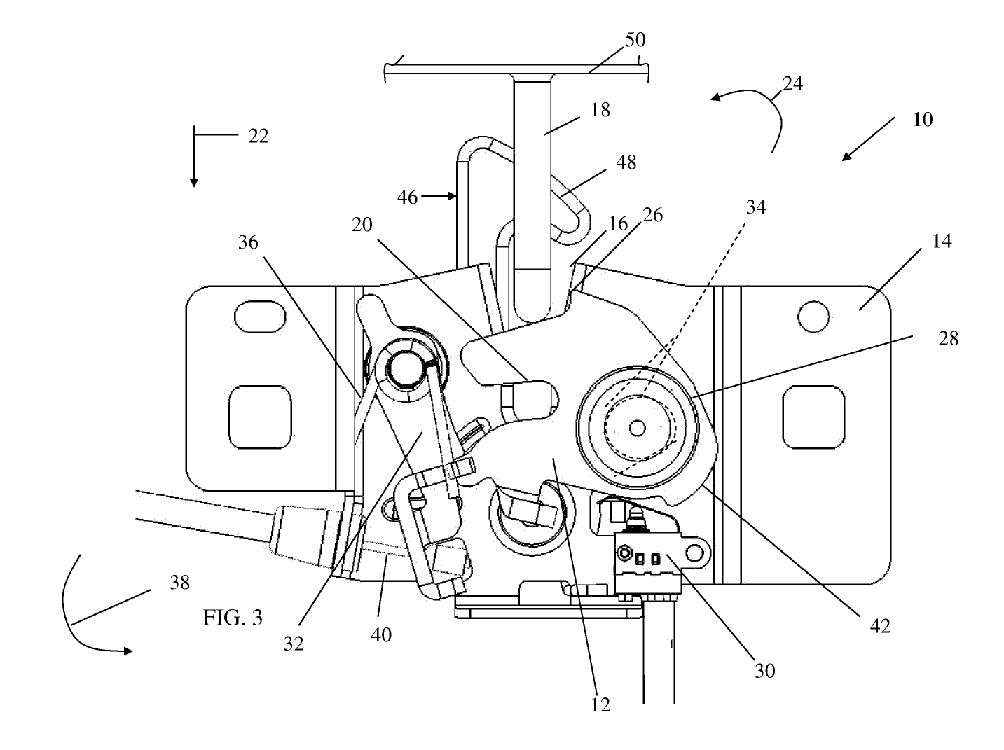

FIG. 4 is a view illustrating the latch assembly of FIG. 1 in a position wherein a feature of the fork bolt has engaged the striker and limited undesirable movement of the fork bolt.

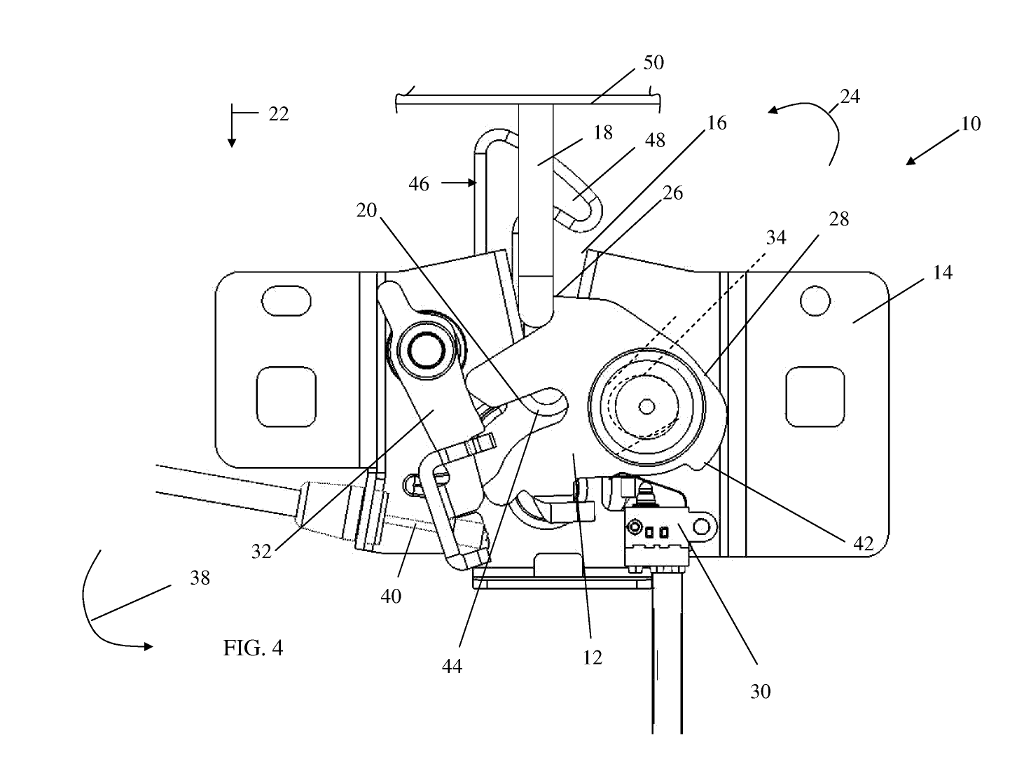

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to a vehicle latch assembly and in one non-limiting exemplary embodiment a hood latch assembly having a feature for limiting movement of a fork bolt of the latch assembly under certain conditions.

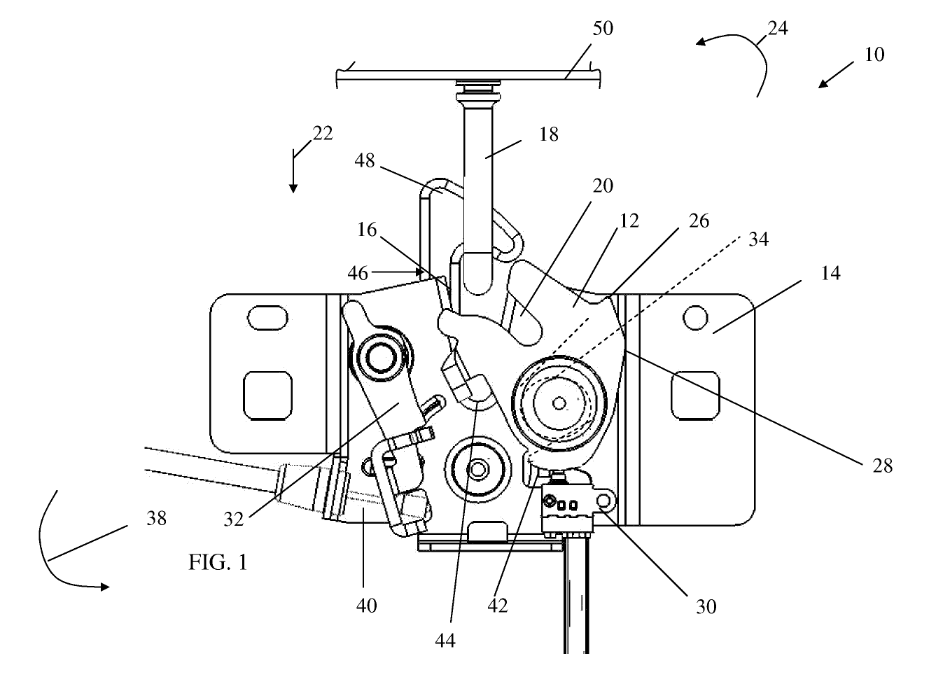

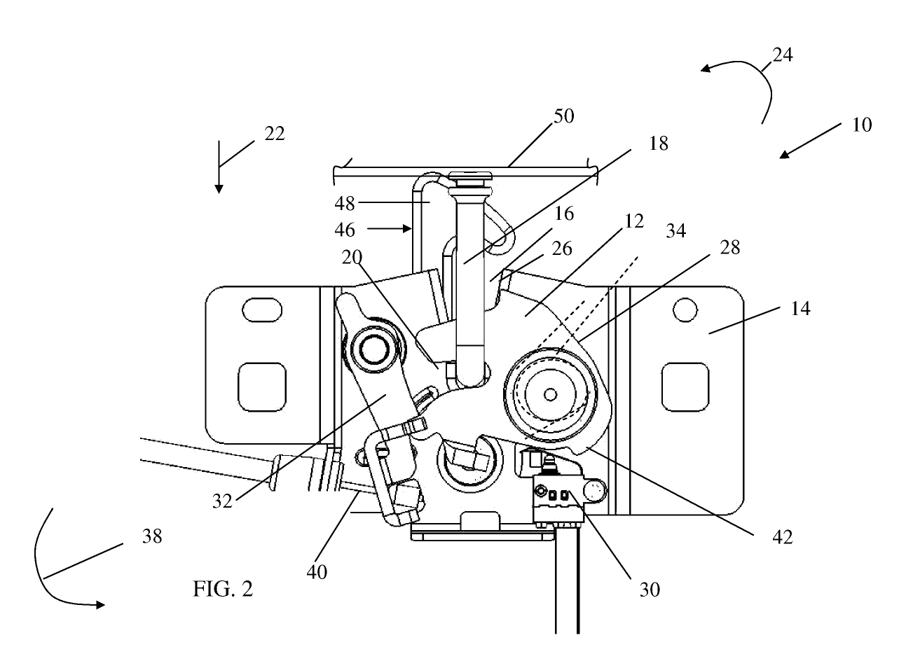

Referring now to FIGS. a latch assembly 10 in accordance with an exemplary embodiment of the present invention is illustrated. Latch assembly 10 has a fork bolt 12 pivotally or rotationally mounted to a housing or frame 14 for movement between a first open or unlatched position illustrated in FIG. 1 and a second or latched position illustrated in FIG. 2.

The frame has an opening 16 for receipt of a striker 18 therein similarly, the fork bolt has an opening 20 or for receipt of the striker therein such that as the striker moves in the direction of arrow 22 and when the fork bolt is in the open position (FIG. 1) the striker will engage and rotate or move the fork bolt in the direction of arrow 24 into the latched position (FIG. 2) wherein the striker is received and engaged in the both openings 16 and 20.

As illustrated, the fork bolt has a feature 26 located on an outer periphery 28 of the fork bolt. The feature is configured to limit pivotal or rotation movement of the fork bolt in the direction of arrow 24 by contacting the striker when the striker is inserted into the striker opening and the striker is not received in the opening of the fork bolt.

This feature is particularly advantageous as certain latch assemblies and in one non-limiting exemplary embodiment hood latch assemblies, a switch 30 (micro-switch or other equivalent structure) is located to provide a signal indicating that the latch assembly is in an open or unlatched state. This signal is provided to a control module or other equivalent processing device, which in one non-limiting exemplary embodiment controls an engine or system of a vehicle on which the latch is mounted.

In order to retain the latch assembly in the latched position, a detent lever 32 is pivotally secured to the latch assembly for movement between an engaged position and a disengaged position, wherein a surface of the fork bolt is engaged by a surface of the detent lever and the fork bolt is prevented from moving toward the unlatched position from the latched position when the detent lever is in the engaged position. In one implementation, a first spring 34 is provided for biasing the fork bolt in a direction opposite to arrow 24 and towards the unlatched position while a second spring 36 is provided for biasing the detent lever in the direction of arrow 38 into the engaged position.

In accordance with exemplary embodiments of the present invention, the fork bolt has an engagement surface or contact surface that slides along and makes contact with a complimentary engagement surface or contact surface of the detent lever when the fork bolt pivots or moves from the open or unlatched position to the closed or latched position and once in the closed position a surface of the fork bolt engages a surface of the detent lever thus engaging the fork bolt and securing it into the closed position when the striker is secured in a receiving opening of the fork bolt. Once the latch is in the closed position the detent lever is spring biased into contact with the fork bolt such that the fork bolt cannot rotate into the open position unless the detent lever is moved back to the release or disengaged detent position.

In order to move the detent lever to the release or disengaged position a release cable or other equivalent component 40 is coupled to the detent lever and the release cable is configured to move the detent lever from the engaged position to the disengaged position.

Accordingly when the striker engages the fork bolt, the fork-bolt is pivoted downward to a latched position where the detent lever blocks the fork-bolt from being biased away from the striker opening to the unlatched position. When the cable is pulled, the detent lever is pivoted out of engagement with the fork bolt allowing the fork-bolt to move to the unlatched position.

As is known in the related arts the frame is adapted for fastening the latch assembly to a vehicle proximate to a compartment closure and the fork bolt or fork bolt lever is pivotally or rotationally mounted to frame plate about a pivot pin or stud that is received within a pivot pin opening of the fork bolt.

The latch assembly is attached to a vehicle structure such that the fork bolt is moved between the open position and the closed position when a hood, door, window, lift gate, etc. is opened and closed and the fork bolt engages a striker that is attached to the hood, door, window, lift gate, etc.

Alternatively, the latch assembly can be secured to the hood, door, window, lift gate, etc. and the striker is secured to the vehicle body at an opening into which the hood, door, window, lift gate, etc. is received.

The detent lever pivots on the frame plate about a pivot pin received within a pivot pin opening in the detent lever. The detent lever cooperates with the fork bolt in a well known manner to retain the fork bolt in the closed position or release the fork bolt for return to the open position. In accordance with an exemplary embodiment of the present invention, the fork bolt is spring biased to the open or unlatched position by a biasing member (e.g., coil spring or other equivalent member) that has one end attached to the fork bolt and the other end attached to the housing or other equivalent location. Similarly, a biasing member or spring will also bias the detent lever in the direction of a face of fork bolt. In addition, the secondary lever will also be spring biased into the first position.

As illustrated in FIG. 1, the switch is actuated by another feature 42 of the fork bolt when the fork bolt is in the unlatched position. In the illustrated embodiment, the another feature is located on the outer periphery of the fork bolt. Still further and as illustrated in FIG. 2, the fork bolt does not make contact with the switch when the fork bolt is in the latched position and further rotational movement of the fork bolt in the direction of arrow 24 is limited by the striker being engaged by a bottom surface 44 of the striker opening and the side walls of the opening of the fork bolt engaging the striker. Alternatively, the side walls and/or the bottom of the striker opening may contact the striker and limit the rotational movement of the fork bolt. In one non-limiting configuration another feature 42 is located on an opposite side of the fork bolt having feature 26 of course numerous configurations and locations are contemplated.

However and if the fork bolt was able to continue to rotate in the direction of arrow 24 the periphery of the fork bolt would ultimately contact the switch 30. In the past this may occur if the striker was inserted into the striker opening and the fork bolt was not completely in the unlatched or open position wherein the opening of the fork bolt was aligned with the striker opening to receive the striker therein.

As such, the fork bolt could continue to rotate in the direction of arrow 24 and contact the switch. This contact would provide at least two undesirable events, damage to the switch by excessive contact and incorrect signals being provided to the vehicle control systems. Therefore, exemplary embodiments of the present invention prevent this by locating a feature 26 on the periphery of the fork bolt.

In one non-limiting embodiment, the latch assembly also has a secondary lever 46 pivotally mounted to the latch assembly for movement between a first position wherein a hasp 48 of the secondary lever is positioned over the striker opening and a second position wherein secondary lever is moved in the direction of arrow 24 and the hasp is no longer positioned over the striker opening such that the striker can be removed from the latch assembly. This is particularly advantageous when the latch assembly is a hood latch assembly and the striker is a hood striker secured to a hood 50 of a vehicle.

Accordingly, the hasp is configured to engage the striker when the striker is inserted in the striker opening and the secondary lever is in the first position. Of course, exemplary embodiments of the present invention are also considered for use with latches that do not have secondary levers.

In accordance with an exemplary embodiment of the present invention, a method of limiting movement of a fork bolt of a vehicle latch assembly is also provided. The method may be described as pivotally securing the fork bolt to the latch assembly for movement between an unlatched position and a latched position and limiting rotational movement of the fork bolt towards the latched position by capturing a striker between a feature disposed on an outer periphery of the fork bolt and a portion of a striker opening of a frame of the latch assembly. By limiting rotational or pivotal movement of the fork bolt in this manner undesirable actuation of a switch by the fork bolt is prevented by capturing the striker between the feature of the fork bolt and the portion of the striker opening of the frame of the latch assembly. As discussed above, this will prevent damage to the switch and erroneous signals from being generated by the switch.

In one implementation switch 30 is provided to provide an indication of an open hood wherein the motor of the vehicle is exposed. In this implementation, the signal of the switch will be used in controllers or microcontrollers coupled to switch 30 wherein the signal is used in an operational protocol of the controller or microcontroller.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A latch assembly, comprising:
a frame having a striker opening formed therein;
a fork bolt pivotally secured to the latch assembly proximate to the striker opening for movement between an unlatched position and a latched position, the fork bolt having an opening configured to engage a striker when the striker is inserted into the striker opening and the fork bolt is in the unlatched position; and
a feature located on an outer periphery of the fork bolt, the feature limiting pivotal movement of the fork bolt by contacting the striker when the striker is inserted into the striker opening and the striker is not received in the opening of the fork bolt.

2. The latch assembly as in claim 1, further comprising:
a detent lever pivotally secured to the latch assembly for movement between an engaged position and a disengaged position, wherein the fork bolt is prevented from moving toward the unlatched position from the latched position when the detent lever is in the engaged position;
a first spring for biasing the fork bolt toward the unlatched position; and
a second spring for biasing the detent lever into the engaged position.

3. The latch assembly as in claim 2, wherein the detent lever is coupled to a release cable, the release cable being configured to move the detent lever from the engaged position to the disengaged position.

4. The latch assembly as in claim 1, further comprising:
a switch secured to the latch assembly, the switch being configured and positioned to be actuated by the fork bolt as it pivots into the unlatched position.

5. The latch assembly as in claim 4, wherein the fork bolt does not make contact with the switch when the fork bolt is in the latched position.

6. The latch assembly as in claim 4, wherein the switch is actuated by another feature of the fork bolt when the fork bolt is in the unlatched position, the another feature being located on the outer periphery of the fork bolt.

7. The latch assembly as in claim 1, further comprising:
a secondary lever pivotally mounted to the latch assembly for movement between a first position, wherein a hasp of the secondary lever is positioned over the striker opening and a second position wherein the hasp is not positioned over the striker opening, the hasp being configured to engage the striker when the striker is inserted in the striker opening and the secondary lever is in the first position.

8. The latch assembly as in claim 1, wherein the latch assembly is a hood latch assembly of a vehicle and the striker is secured to a hood of the vehicle.

9. The latch assembly as in claim 1, further comprising:
a switch secured to the latch assembly, the switch being configured and positioned to be actuated by the fork bolt as it pivots into the unlatched position and wherein the fork bolt does not make contact with the switch when the fork bolt is in the latched position; and
a secondary lever pivotally mounted to the latch assembly for movement between a first position, wherein a hasp of the secondary lever is positioned over the striker opening and a second position wherein the hasp is not positioned over the striker opening, the hasp being configured to engage the striker when the striker is inserted in the striker opening and the secondary lever is in the first position.

10. The latch assembly as in claim 9, wherein the switch is actuated by another feature of the fork bolt when the fork bolt is in the unlatched position, the another feature being located on the outer periphery of the fork bolt.

11. The latch assembly as in claim 9, wherein the latch assembly is a hood latch assembly of a vehicle and the striker is secured to a hood of the vehicle.

12. A hood latch assembly in combination with a hood striker, comprising:
a frame having a striker opening formed therein;
a fork bolt pivotally secured to the latch assembly proximate to the striker opening for movement between an unlatched position and a latched position, the fork bolt having an opening configured to engage the hood striker when the hood striker is inserted into the striker opening and the fork bolt is in the unlatched position; and
a feature located on an outer periphery of the fork bolt, the feature limiting pivotal movement of the fork bolt when the hood striker is inserted into the striker opening and the hood striker is not received in the opening of the fork bolt, wherein the hood striker is captured between the feature and a surface of the striker opening as the fork bolt pivots to the latched position when the hood striker is inserted into the striker opening and the hood striker is not received in the opening of the fork bolt.

13. The hood latch assembly as in claim 12, further comprising:
a detent lever pivotally secured to the latch assembly for movement between an engaged position and a disengaged position, wherein the fork bolt is prevented from moving toward the unlatched position from the latched position when the detent lever is in the engaged position;
a first spring for biasing the fork bolt toward the unlatched position; and
a second spring for biasing the detent lever into the engaged position.

14. The hood latch assembly as in claim 13, wherein the detent lever is coupled to a release cable, the release cable being configured to move the detent lever from the engaged position to the disengaged position.

15. The hood latch assembly as in claim 12, further comprising:
a switch secured to the latch assembly, the switch being configured and positioned to be actuated by the fork bolt as it pivots into the unlatched position.

16. The hood latch assembly as in claim 15, wherein the fork bolt does not make contact with the switch when the fork bolt is in the latched position.

17. The hood latch assembly as in claim 15, wherein the switch is actuated by another feature of the fork bolt when the fork bolt is in the unlatched position, the another feature being located on the outer periphery of the fork bolt.

18. The hood latch assembly as in claim 12, further comprising:
a secondary lever pivotally mounted to the latch assembly for movement between a first position, wherein a hasp of the secondary lever is positioned over the striker opening and a second position wherein the hasp is not positioned over the striker opening, the hasp being configured to engage the hood striker when the hood striker is inserted in the striker opening and the secondary lever is in the first position.

19. The hood latch assembly as in claim 12, further comprising:
a switch secured to the latch assembly, the switch being configured and positioned to be actuated by the fork bolt as it pivots into the unlatched position and wherein the fork bolt does not make contact with the switch when the fork bolt is in the latched position; and
a secondary lever pivotally mounted to the latch assembly for movement between a first position, wherein a hasp of the secondary lever is positioned over the striker opening and a second position wherein the hasp is not positioned over the striker opening, the hasp being configured to engage the hood striker when the hood striker is inserted in the striker opening and the secondary lever is in the first position.

20. A method of limiting movement of a fork bolt of a vehicle latch assembly, the method comprising:
pivotally securing the fork bolt to the latch assembly for movement between an unlatched position and a latched position;
limiting rotation of the fork bolt towards the unlatched position by capturing a striker between a feature disposed on an outer periphery of the fork bolt and a portion of a striker opening of a frame of the latch assembly; and
preventing actuation of a switch by the fork bolt when the striker is captured between the feature of the fork bolt and the portion of the striker opening of the frame of the latch assembly.
